(19) United States
(12) Patent Application Publication
(10) Pub. No.: US 2017/0100845 A1
(43) Pub. Date: Apr. 13, 2017

(54) Children's Ergonomic Scissors

(71) Applicant: Acme United Corporation, Fairfield, CT (US)

(72) Inventor: Sarah A. Albano, Fairfield, CT (US)

(21) Appl. No.: 15/059,649

(22) Filed: Mar. 3, 2016

Related U.S. Application Data
(60) Provisional application No. 62/240,559, filed on Oct. 13, 2015.

(51) Int. Cl. B26B 13/28; B25G 1/10; B26B 13/20

(52) U.S. Cl. CPC B26B 13/285; B26B 13/20; B25G 1/102

(57) ABSTRACT

A pair of scissors especially designed for children incorporates various ergonomic features to facilitate usage by a child. The shank and handle of one scissor are disposed at an offset angle to the blade. An assist leaf is pivotally mounted to one of the handles and is movable to engage the other handle to establish a minimum opening angle for the blades. The assist leaf in its functional position is resilient and imparts a slight spring reaction force upon application of a compressive force between the thumb and fingers. The minimum opening angle facilitates usage by the child since the opening and closing force on the scissors is lessened. The leaf is pivotal to a retracted position when the blades are in a fully closed position.

### BACKGROUND

This disclosure relates generally to scissors adapted for use by children. More particularly, this disclosure relates generally to ergonomic scissors.

For scissors to which the present disclosure relates, a number of related prior art scissors have been especially configured for use by children. Typically, such scissors are light weight and dimensioned to accommodate the hands, fingers and thumb of a child. Such scissors are also colorfully configured and/or are shaped and decorated to appeal to children.

### SUMMARY

Briefly stated, a pair of ergonomic children's scissors comprises a first scissor having a first blade extending from a first shank mounting a first handle with a thumb opening and a second scissor having a second blade extending from a second shank mounting a second handle with a finger opening. The second blade is disposed at an angle relative to said second shank. A connection assembly pivotally connects the first scissor to the second scissor about a first pivot axis. An assist is selectively positionable to define an established blade opening acute angle of the first and second blades.

The first and second handles are comprised of soft overmold material. The assist is mounted to the first handle and engages the second handle to define the blade opening acute angle. The assist is pivotal about a second axis parallel to the first axis. In one embodiment, the assist comprises an arcuate leaf. The assist is received in a recess of the first handle when the first and second blades are in a closed position. The assist has an angular stop. The blade opening acute angle is approximately 30°.

A pair scissors are pivotally joined by a connection assembly. The first scissor has a first blade and a first shank mounting a handle with a thumb opening. The first blade and the first shank are generally co-linear. The second scissor has a blade and a second shank mounting a handle with a finger opening. The second blade has a second blade axis and the second shank has a second shank axis relative to the second blade axis disposed at an offset angle. In one embodiment, the offset angle is approximately 30°. An assist is mounted to a first handle and is pivotal about a second pivot axis parallel to the first pivot axis. The assist is engageable against the second handle to define an established opening angle of the blades and assist in the pivotal or reciprocating motion of the blades.

The first and second handles further comprise soft overmold material. A series of shallow indentations extend away from the blade opening and the finger opening of the first and second handles. The opening angle is preferably between 15° and 45°. In one embodiment, the opening angle is approximately 30°.

In one embodiment, the ergonomic children's scissors comprises a first scissor having a first blade and a first shank mounting a handle with a thumb opening and having a recess. The first blade and the first shank are generally co-linear. A second scissor has a second blade and a second shank mounting a handle with a finger opening. The second shank is disposed at an offset crank angle to the second blade axis. The offset angle is preferably in the range of 15° to 45°. An assist is pivotally mounted to the first handle and pivotal about a second pivot axis parallel to the first pivot axis. The assist pivots from a first position received in the recess to a second position engageable against the second handle to define an opening angle of the blade.

### BRIEF DESCRIPTION OF THE DRAWINGS

FIG. 1 is a perspective view of the children's ergonomic scissors in a closed position;

FIG. 2 is a front view of the closed children's ergonomic scissors of FIG. 1;

FIG. 3 is a rear diagrammatic view of the closed children's ergonomic scissors of FIG. 1;

FIG. 4 is a diagrammatic top plan view of the closed children's ergonomic scissors of FIG. 1;

FIG. 5 is a bottom plan view of the closed children's ergonomic scissors of FIG. 1;

FIG. 6 is an enlarged left side view of the closed children's ergonomic scissors of FIG. 1;

FIG. 7 is an enlarged right side view of the closed children's ergonomic scissors of FIG. 1;

FIG. 8 is a perspective view of the children's ergonomic scissors of FIG. 1 illustrated in an opened position;

FIG. 9 is a rear diagrammatic view of the opened children's ergonomic scissors of FIG. 8;

FIG. 10 is a front view of the opened children's ergonomic scissors of FIG. 8;

FIG. 11 is a top plan view of the opened children's ergonomic scissors of FIG. 8;

FIG. 12 is a bottom plan view of the opened children's ergonomic scissors of FIG. 8;

FIG. 13 is an enlarged left side view of the opened children's ergonomic scissors of FIG. 8;

FIG. 14 is an enlarged right side view of the opened children's ergonomic scissors of FIG. 8;

FIG. 15 is an enlarged view, partly in schematic, of the children's ergonomic scissors of FIG. 1 illustrated in an exaggerated opened position; and

FIG. 16 is an enlarged diagrammatic view of the children's ergonomic scissors of FIG. 9 further illustrating an offset angle relationship and a blade opening angle.

### DETAILED DESCRIPTION

With reference to the drawings wherein like numerals represent like parts throughout the figures, a pair of children's ergonomic scissors is generally designated by the numeral 10. Ergonomic scissors 10 comprises a first scissor 20 and a second scissor 40 which are pivotally joined at a pivot assembly 60.

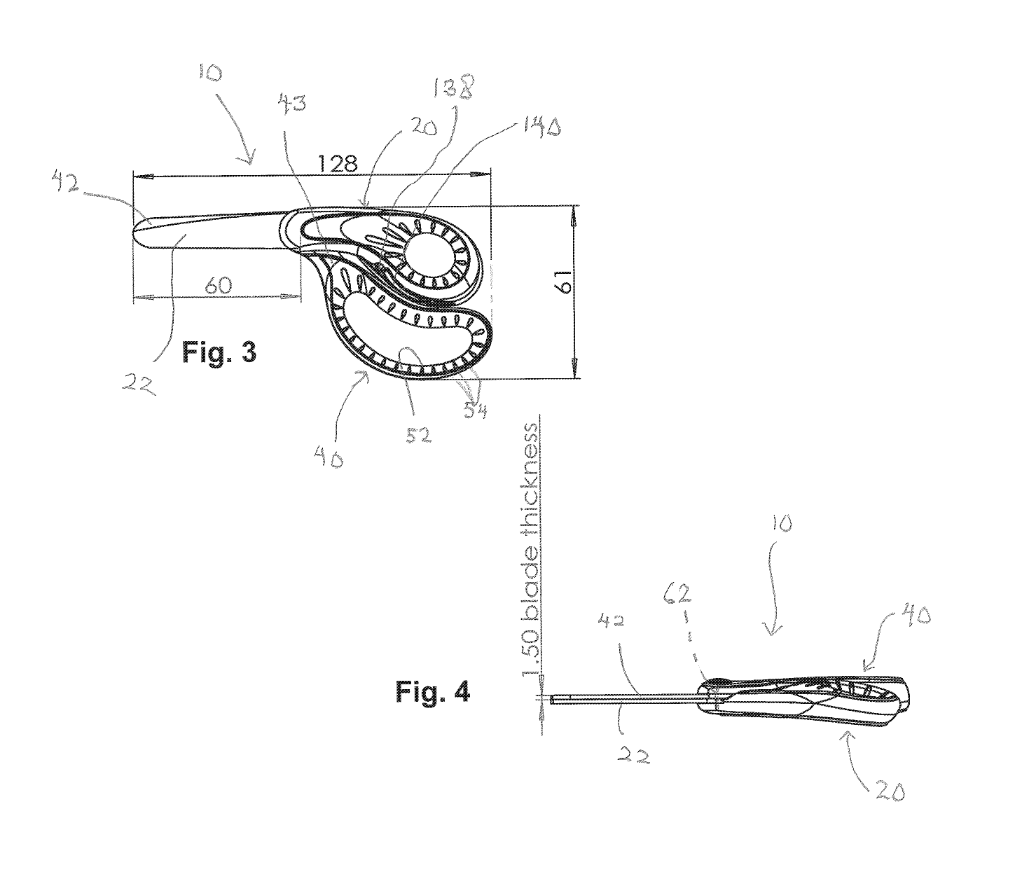

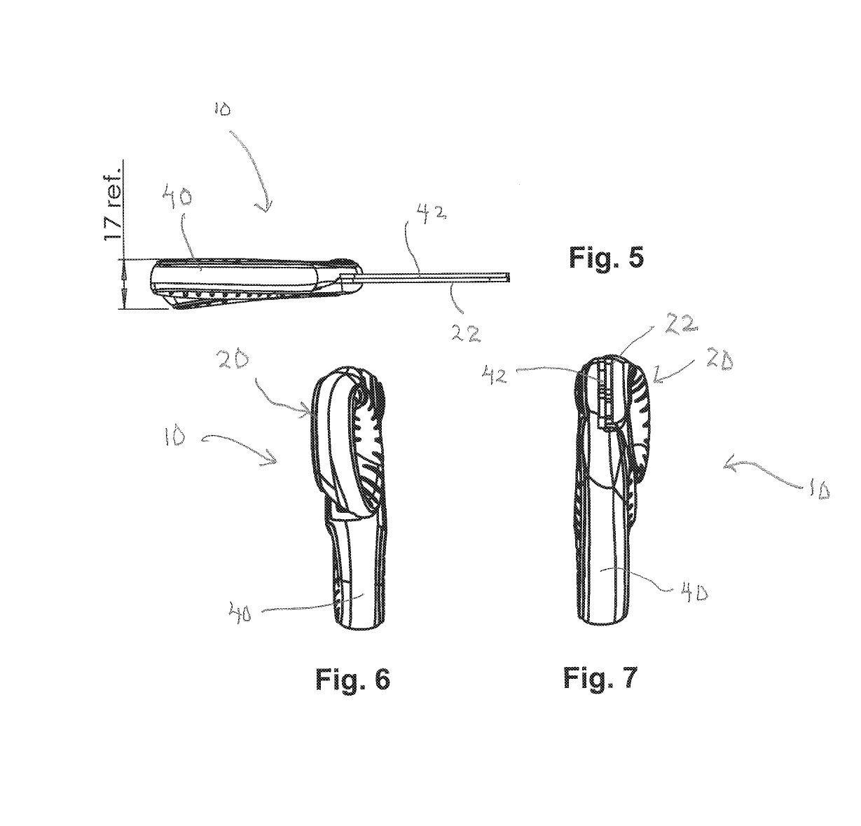

First scissor 20 includes a blade 22 that is somewhat dull at its cutting edge 24 and contoured or beveled at the opposite edge 26. A shank 23 integrally extends from the blade. The blade 22 and the shank 23 are generally co-linear or only slightly angled to each other. An overmold 28 integrally extends rearwardly over the shank 23 (partially illustrated) to form a rear handle 30. The handle 30 defines a thumb opening 32. The thumb opening 32 is dimensioned to accommodate a thumb of a child. The representative dimensions in FIGS. 3-5 are in millimeters.

The handle 30 is preferably formed of a soft molded material, such as polypropylene (PPE) and preferably has a smooth two-color contour which tapers very gradually from a central portion toward the thumb opening. Numerous shallow indentations 34 extend from proximate the opening 32 of both sides of the first scissor onto the handle to form an interrupted surface to facilitate an effective grip for the child. The medial portion of the first member includes an opening (not illustrated) for receiving a pivot connecting assembly 60, as will be later described.

The second scissor 40 has a crank-like configuration which forms a forward blade 42 which has a generally dull cutting edge 44 and an opposite contoured or beveled edge 46. The cutting edge 44 cooperates with cutting edge 24 to implement the cutting function. The second scissor 40 has a medial opening (not illustrated) which receives the pivot assembly 60.

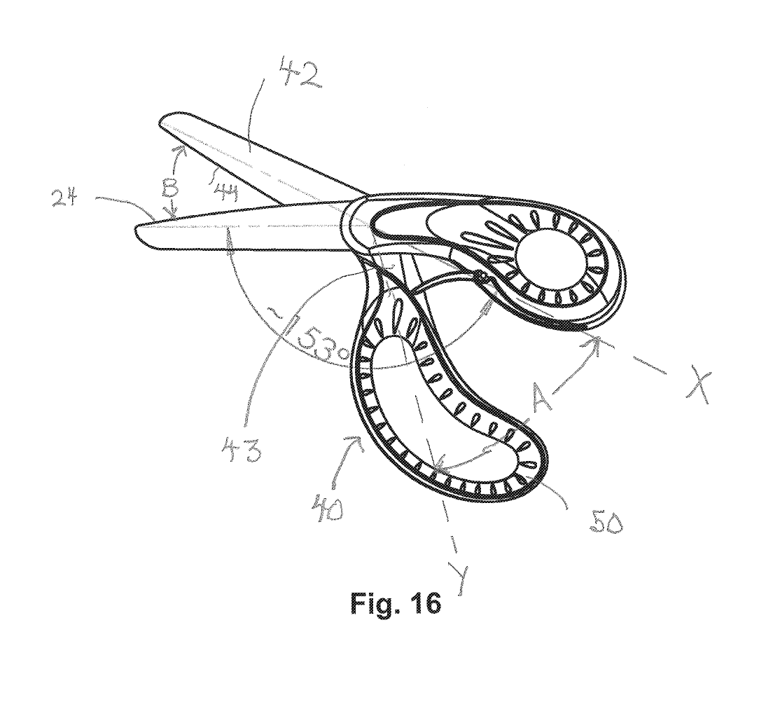

A rear angled shank 43 (partially illustrated) integrally extends rearwardly from the blade 42 in an integral fashion and is preferably bifurcated. The offset angle A between the blade 42 and the shank 43, as best illustrated in FIG. 16 is preferably approximately 30° and may have an angle in the range of approximately 15°-45° to provide the desired ergonomic function. An overmold 48 of soft material, such as PPE, covers the shank end portion to form a rear handle 50 of the second scissor. The handle 50 defines an oblong arcuate finger opening 52 for accommodating the fingers of a child. Numerous shallow indentations 54 extend from proximate the finger opening 52 onto the outer surface of the overmold 48 on both sides of the handle to form an effective grip surface. The handle 50 preferably has a soft, smooth two-color configuration.

With reference to FIG. 16, it is preferred that the angle A between the axis X of the blade 42 and the handle of the central axis Y of shank 43 is disposed at a substantially 30° acute angle, as indicated in the FIG. 16 drawing. The foregoing approximate 30° acute angle is believed to provide an optimal pivot angle for facilitating the reciprocating opening and closing of the scissors due to the manual manipulation by a child.

With reference to FIGS. 4 and 12, the pivot assembly 60, which may include a fastener or pin 62 (shown in phantom) of various forms, connects through the openings (not illustrated) of the first scissor 20 and the second scissor 40, respectively, and is secured by various forms to pivotally join the scissors. A light torsion spring (not illustrated) may be received in cooperative recesses surrounding the openings, respectively. The torsion spring preferably surrounds the central fastener pin 62. The spring includes ends which are anchored at openings or anchors, respectively, in opposed adjacent sides of the first and second scissors proximate the pivot. The optional spring functions to assist the child by providing a small spring force to open the scissors to facilitate cutting. Alternative or no spring configurations may be provided.

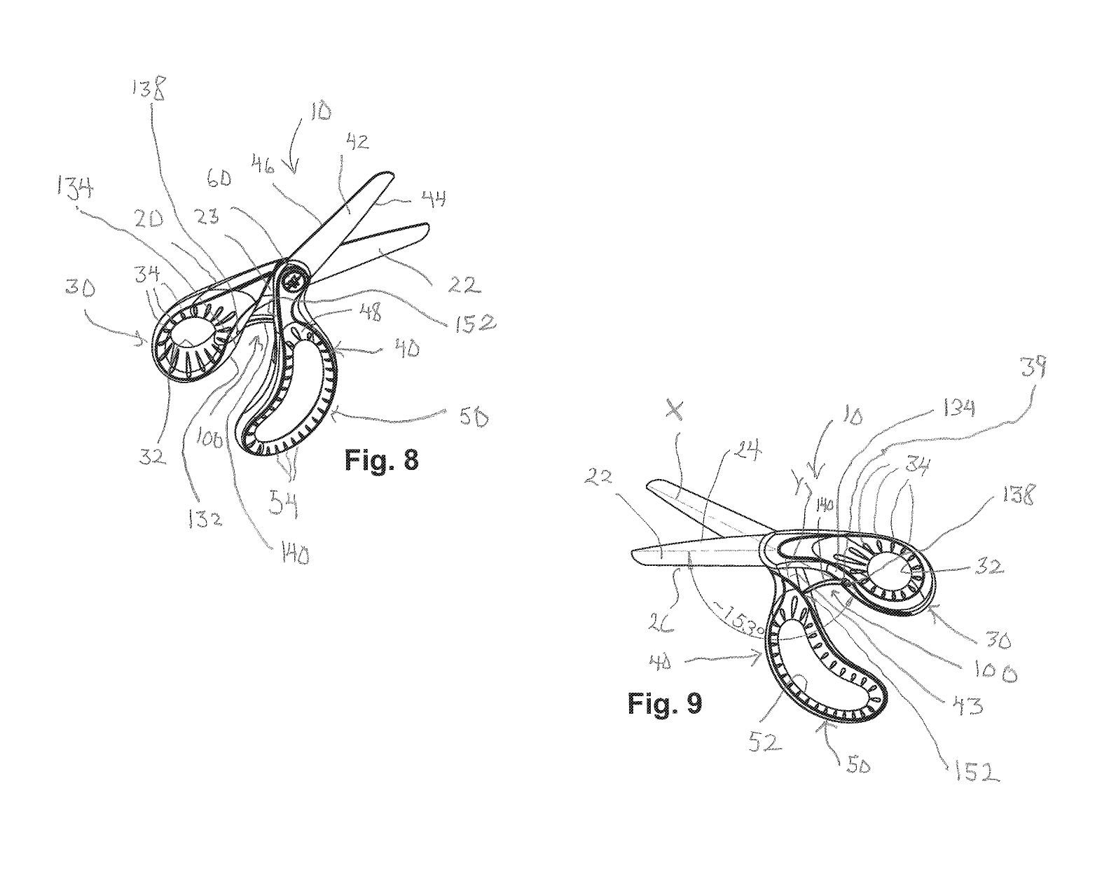

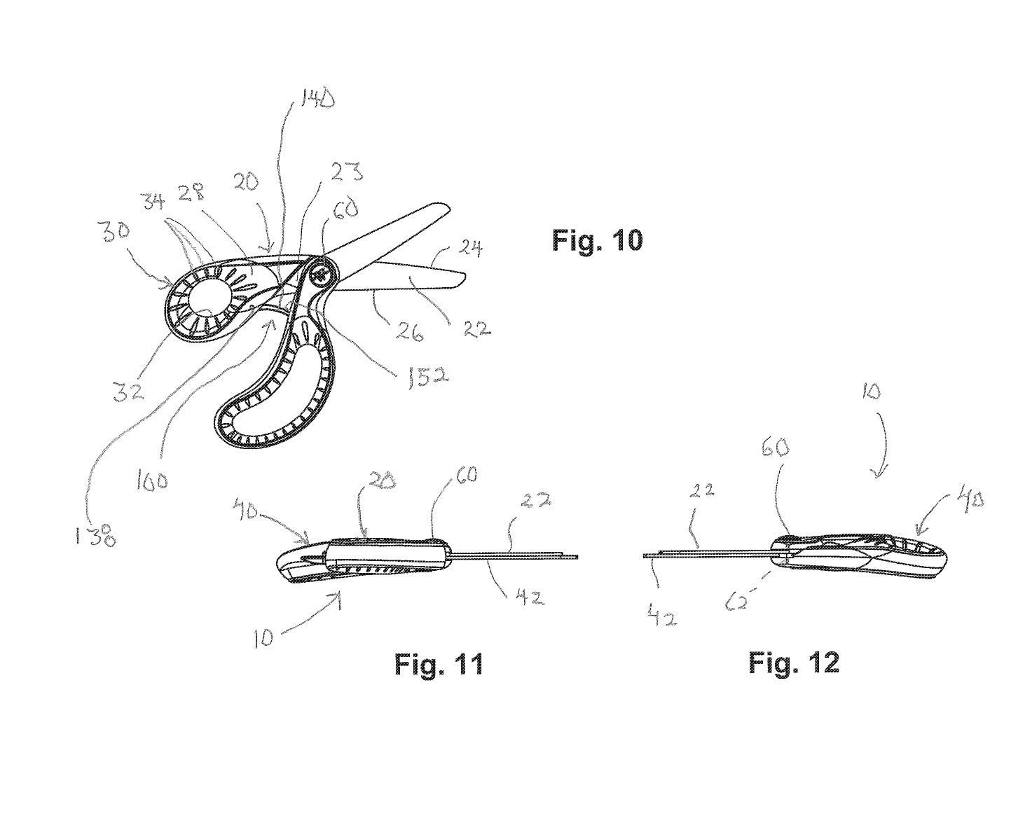

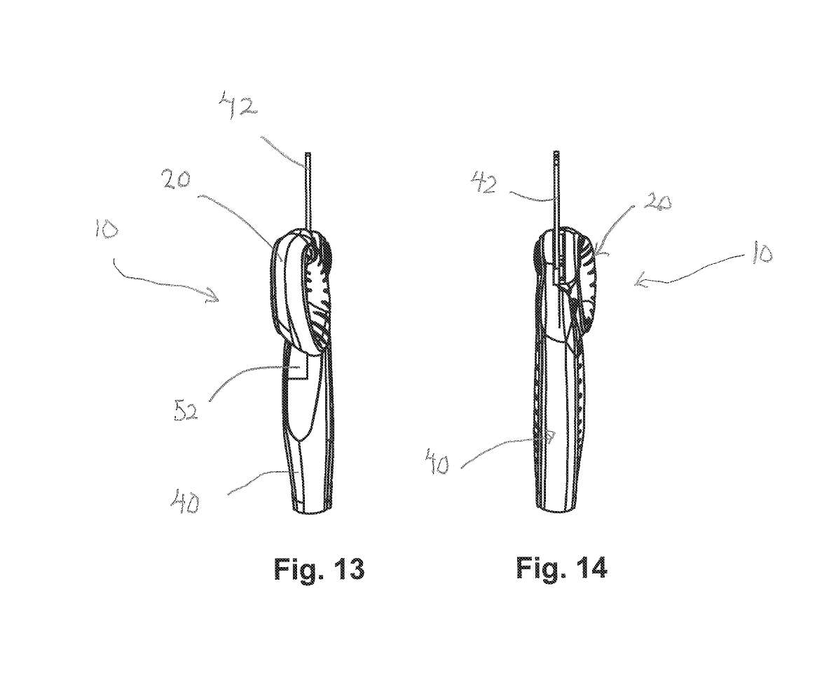

With reference to FIGS. 8-16, an assist assembly which functions to establish a minimum acute opening angle B (FIG. 16) for the scissors and a small spring blade opening force is generally designated by the numeral 100. The opening angle B between blades 22 and 42 may vary, but in one preferred embodiment, is approximately 30°, and is preferably between 15° and 45°, although other angles are possible and may be suitable for use by a child. The preset minimum opening angle B functions to facilitate reciprocating pivotal motion of the blades 22 and 42 particularly so that a fully closed position is not required and the child can continue to impart a small angular reciprocating motion to the blades without exertion of a significant opening or closing force.

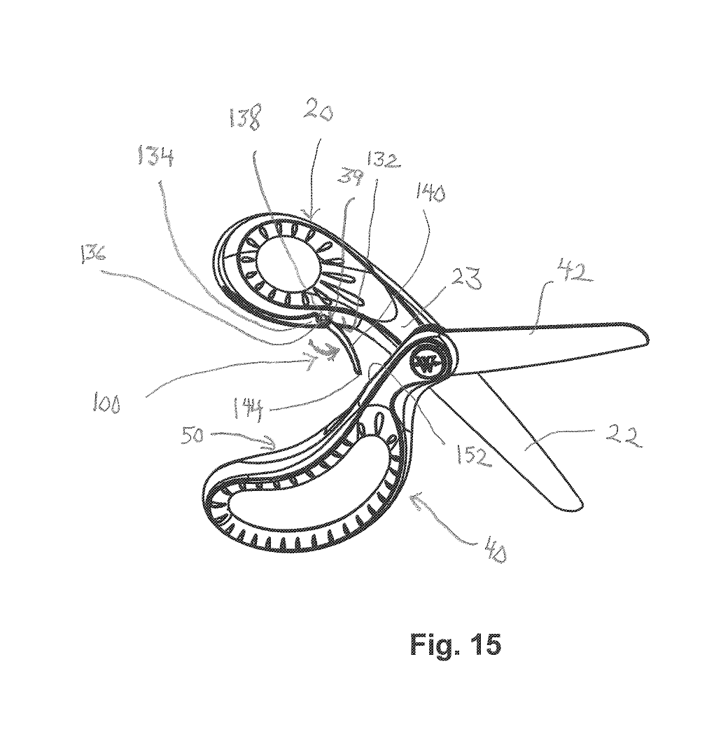

A first handle 30 has an inner exterior surface 132 traversed by a contoured recess 134. A boss 136 at the forward end of the recess receives a pivot pin 138. At one proximal end, an arcuate leaf-like member 140 includes a protruding connector 142 which receives the pivot pin. The recess 134 is generally contoured and dimensioned to receive the assist member 140. The member 140 is angularly pivotal from the recess about the pivot axis of pin 138 (which is parallel to the pivot axis of the scissor members) in the direction of the FIG. 15 arrow.

The rear portion of the handle 30 surface includes a limit, or stop 39 which limits the pivoting of the leaf member 140. It will be appreciated that the leaf member 140 is pivotally positionable from a retracted position totally captured in the recess to an extended position wherein the distal end 144 of the leaf member engages a surface 152 of the handle 50.

The engagement substantially defines a minimum acute angle of the scissor blades subject to the slight resistance of the leaf member 140, as best shown in the drawings of FIGS. 8-10 and 15. The pivot angle of the leaf member 140 may be slightly varied, but is optimally stably positioned at the extreme forward pivotal position of the leaf member. This pre-established blade opening allows for the child to easily open and close the scissors through appropriate exertion of force in the finger openings and the thumb opening and thus allow the child to cut a paper disposed between the blades. The leaf member 140 is slightly resilient to provide a spring assist when the child moves the thumb and fingers together. A slight spring-like reaction force is imparted by the assist member 140 upon application of a compressive force to the handles. In one embodiment (not illustrated), various detents may be integrally formed on the handle surface 152 to provide for various angle adjustments to the leaf member, and thus slightly vary the acute opening angles for the blades.

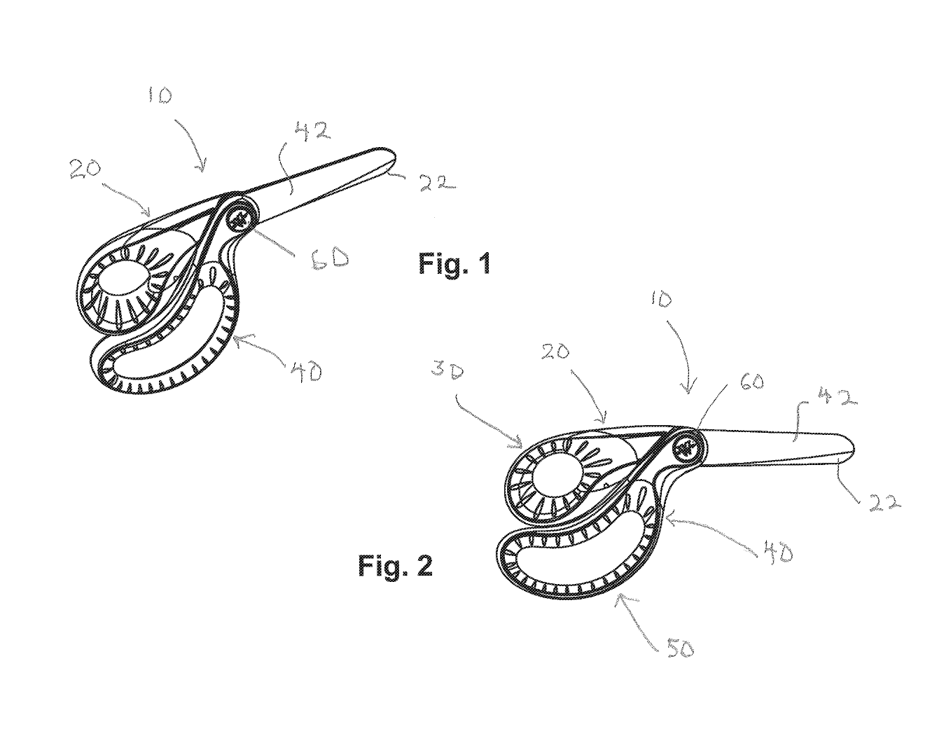

It will be appreciated that when the scissors are not used and are placed in the blade closed position, such as illustrated in FIGS. 1-3, the leaf member 140 is rearwardly pivoted into the handle recess 134. For more advanced usage by a child, the leaf member 140 can be maintained in the retracted position, and the child can operate the scissors in a more normal fashion.

It will be appreciated that the foregoing scissors 10 provides an ergonomic pair of scissors which are especially adapted for use by children. The operation of the scissors by the child can be performed in a very comfortable and effective fashion by the child.

While preferred embodiments of the foregoing have been set forth for purposes of illustrating the children's ergonomic scissors, the foregoing description should not be deemed a limitation of the invention herein. Accordingly, various modifications, adaptations and alternatives may occur to one skilled in the art without departing from the spirit and the scope of the present invention.

1. Ergonomic children's scissors comprising:
a first scissor having a blade extending from a first shank mounting a first handle defining a thumb opening;
a second scissor having a second blade extending from a second shank mounting a second handle defining a finger opening, wherein said second blade is disposed at an offset angle relative to said second shank;
a connection assembly pivotally connecting said first scissor to said second scissor about a first pivot axis; and
an assist which is selectively positionable to define an established blade opening acute angle of the first and second blades.

2. The children's ergonomic scissors of claim 1 wherein said first and second handles further comprise soft overmold material.

3. The children's ergonomic scissors of claim 2 further comprising a series of shallow indentations extending away from said thumb opening and said finger opening of said first and second handles.

4. The children's ergonomic scissors of claim 1 wherein said assist is mounted to said first handle and engages said second handle to define said blade opening acute angle.

5. The children's ergonomic scissors of claim 1 wherein said assist is pivotal about a second axis parallel to said first axis.

6. The children's ergonomic scissors of claim 1 wherein said assist comprises an arcuate leaf.

7. The children's ergonomic scissors of claim 4 wherein said assist is received in a recess of said first handle when said first and second blades are in a closed position.

8. The children's ergonomic scissors of claim 1 wherein said assist has an angular stop.

9. The children's ergonomic scissors of claim 1 wherein said blade opening acute angle is approximately 30°.

10. The children's ergonomic scissors of claim 1 wherein said offset angle is between 15° and 45°.

11. Ergonomic children's scissors comprising:
a first scissor having a first blade and a first shank mounting a handle defining a thumb opening, said first blade and said first shank defining a generally co-linear or slightly angled relationship;
a second scissor having a second blade and a second shank mounting a handle defining a finger opening, wherein said second blade defines a second central blade axis and said second shank defines a second axis disposed at an offset angle relative to said second blade axis;
a connection assembly pivotally connecting said first scissor to said second scissor about a first pivot axis; and
an assist mounted to said first handle and pivotal about a second pivot axis parallel to said first pivot axis and engageable against said second handle to define an established opening angle of the blades and assist in the pivotal reciprocating motion of said blades.

12. The children's ergonomic scissors of claim 11 wherein said offset angle is between 15° and 45°.

13. The children's ergonomic scissors of claim 12 wherein said offset angle is approximately 30°.

14. The children's ergonomic scissors of claim 11 wherein said opening angle is between 15° and 45°.

15. The children's ergonomic scissors of claim 14 wherein said opening angle is approximately 30°.

16. The children's ergonomic scissors of claim 11 wherein said assist is resilient.

17. The children's ergonomic scissors of claim 11 wherein said assist is received in a recess of said first handle when said first and second blades are in a closed position.

18. Ergonomic children's scissors comprising:
a first scissor having a first blade and a first shank mounting a handle defining a thumb opening and a recess;
a second scissor having a second blade and a second shank mounting a handle defining a finger opening, wherein said second blade defines a second central blade axis and said second shank defines a second axis relative to said second blade axis disposed at an offset angle between 15° and 45°;
a connection assembly pivotally connecting said first scissor to said second scissor about a first pivot axis; and
an assist pivotally mounted to said first handle and pivotal about a second pivot axis parallel to said first pivot axis from a first position received in said recess to a second position engageable against said second handle to define an opening angle of the blades.

19. The ergonomic children's scissors of claim 18 wherein said assist is a leaf-like member which is slightly concave and is slightly resilient.

20. The ergonomic children's scissors of claim 18 wherein said opening angle of the blades is between 15° and 45°.
